(19) United States
(12) Patent Application Publication
(10) Pub. No.: US 2024/0257189 A1
(43) Pub. Date: Aug. 1, 2024

(54) DONATION-BASED TRANSACTION INTEGRATION

(71) Applicant: NCR Voyix Corporation, Atlanta, GA (US)

(72) Inventors: Kip Oliver Morgan, Atlanta, GA (US); Gina Torcivia Bennett, Lawrenceville, GA (US); Wuchieh James Jong, Raleigh, NC (US); Kelli Lee, Atlanta, GA (US); Jerry Steven Massey, Lawrenceville, GA (US); Jacob Alexander Poston, Loganville, GA (US); Aleah Jean Kadry, Atlanta, GA (US)

(21) Appl. No.: 18/104,035

(22) Filed: Jan. 31, 2023

(51) Int. Cl. G06Q 30/0279; G06Q 20/10; G06Q 20/36; G06Q 20/38

(52) U.S. Cl. CPC G06Q 30/0279; G06Q 20/10; G06Q 20/3678; G06Q 20/389

(57) ABSTRACT

A donation workflow with donation screens is integrated into a transaction workflow of a transaction terminal. The donation workflow is independent and separate from the transaction workflow. When a customer enters a donation into a donation entry screen, an agent on the terminal provides the donation amount to a transaction manager of the terminal. The donation amount is added as a line item to the transaction total. After payment, the fiat currency associated with the donation amount is used to purchase an equivalent amount in cryptocurrency over a blockchain and held in a store wallet of a store. The equivalent amount in cryptocurrency is subsequently transferred over the blockchain from the store wallet to a charity's wallet associated with the charity that is to receive the donation amount from the customer.

### BACKGROUND

Events such as war and natural disaster can affect millions of people's lives instantaneously; people watching the news want a fast, direct way to help. Collecting donations at self-checkouts and other point-of-sale (POS) systems is not uncommon. Typically, when ordering, a cashier asks a customer if the customer wants to donate or round up to the nearest dollar of their bill to donate to a predefined charity. This makes the customer feel uncomfortable with people standing in line behind them and with the cashier. Some customers feel pressure to donate even when they are not happy about the situation, other customers refuse to donate out of principle because of the pressure even when they would have otherwise donated if not asked by the cashier. Most customers do not like being asked by a cashier if they would like to donate to a charity at checkout.

People in need usually need help immediately and urgently. Infrastructures and resources, such as bank account access, can be compromised in times of natural disaster. People want to donate, but they want transparency in where their money is going to and how it is being allocated. It is difficult for people to verify which donation groups are the best. Furthermore, organizing funding campaigns is difficult and time consuming and most people do not want to take ownership of such tasks.

### SUMMARY

In various embodiments, methods and a system for donation-based transaction integration are presented. Charitable organizations are registered to receive donations from a store. During registration, the organization's cryptocurrency wallet identifier is obtained and a summary page of information about the organization and its charitable works are obtained. The charitable organizations are vetted using third-party services and/or a blockchain ledger to determine whether those organizations meet certain standards of a given retail store.

Interfaces are provided for store managers to add and search for vetted charitable organizations. A time period is set by the manager, which allows the manager to select a particular charitable organization for a current period of time at the store or at a group of stores. At the start of a current period of time, an agent on the transaction terminals of the store permits customers to read the summary page for the selected organization and add a charitable donation onto their transaction total to donate to the organization. The donated funds are used to purchase cryptocurrency into a wallet held by the store. At the end of each day or a preset elapsed period of time, the cryptocurrency in the store's wallet is transferred to the selected organization's wallet over the blockchain. The store can use the ledger maintained on the blockchain for the store's wallet to produce summaries and reports on the donations made by the store by charity and selected periods of time.

### BRIEF DESCRIPTION OF THE DRAWINGS

FIG. 1A is a diagram of a system for donation-based transaction integration, according to an example embodiment.

FIG. 1B is a sample screen generated by a terminal agent that includes a customer option to donate to a charitable organization during a transaction on a terminal, according to an example embodiment.

FIG. 1C is a sample screen generated by a terminal agent that includes entry fields for the customer to indicate a specific donation amount, according to an example embodiment.

FIG. 1D is a sample screen generated by a transaction manager of the terminal that shows a total for the customer transaction with the donation amount included with other items purchased by the customer, according to an example embodiment.

FIG. 1E is a diagram illustrating the screen transitions during a transaction in which a donation is made by a customer, according to an example embodiment.

FIG. 2 is a flow diagram of a method for donation-based transaction integration, according to an example embodiment.

FIG. 3 is a flow diagram of another method for donation-based transaction integration, according to an example embodiment.

### DETAILED DESCRIPTION

As stated above, current approaches to collecting donations can seem too public and can be associated with too much pressure such that many customers are uncomfortable with donation requests by cashiers during checkout. The approach taken herein and below is to pre-vet potential charitable organizations and integrate donation requests seamlessly into the transaction workflow without substantially modifying the transaction workflow at the transaction terminals. Charitable donation requests are only pursued upon the private and affirmative request of the customer during checkout. Donations received are managed in a store cryptocurrency wallet and sent, at predefined intervals of time, to designated wallets of the charitable organizations over the blockchain. A ledger maintained on the blockchain (BC) permits reports to be generated to illustrate the donations made by the store during user-defined periods of time and to which organizations the donations were given.

As used herein, a “fiat currency” is a government backed currency, such as U.S. dollars, European Euros, Mexican Pesos, Brazilian Reals, etc. A “cryptocurrency” includes different types, such as Bitcoin® (BTC), Ethereum® (ETH), Dodgecoin® (Dodge), etc.

The terms “consumer,” “customer,” and/or “donator” may be used synonymously and interchangeable herein. This is an individual who is performing a checkout at a transaction terminal and elects to make a donation to a store-selected charity by including a donation amount above the transaction total when paying for the transaction.

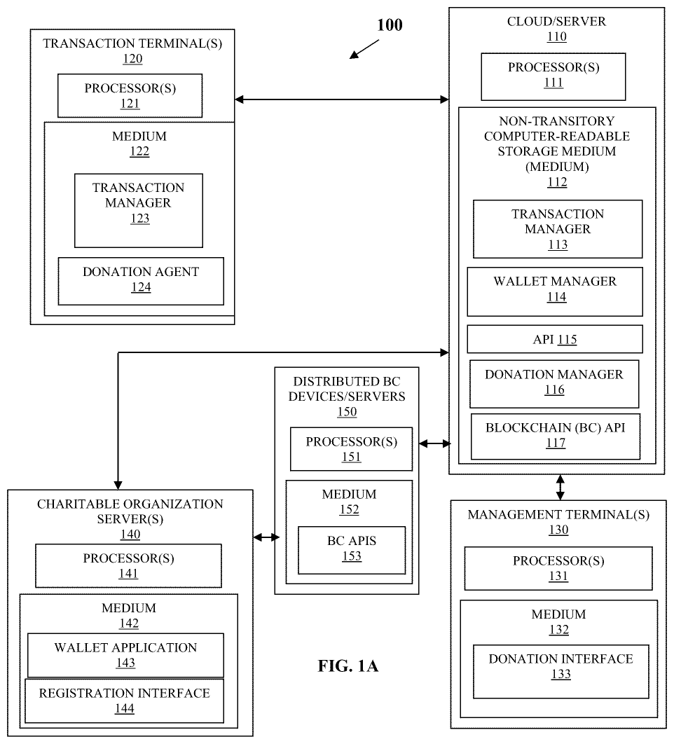

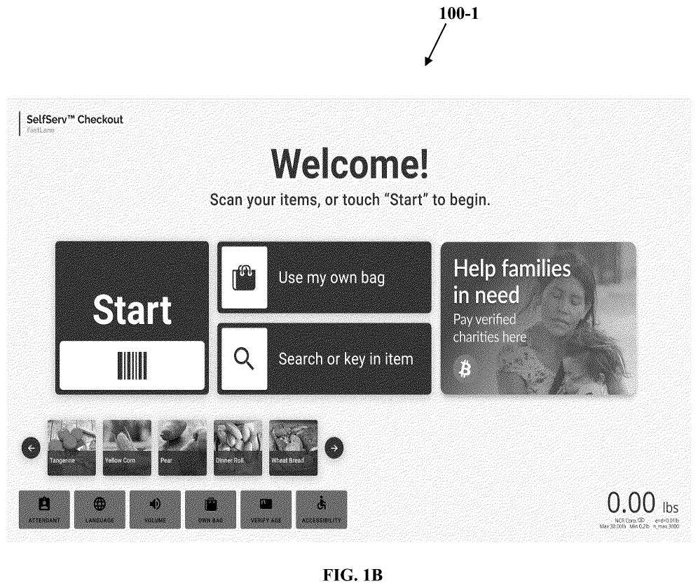

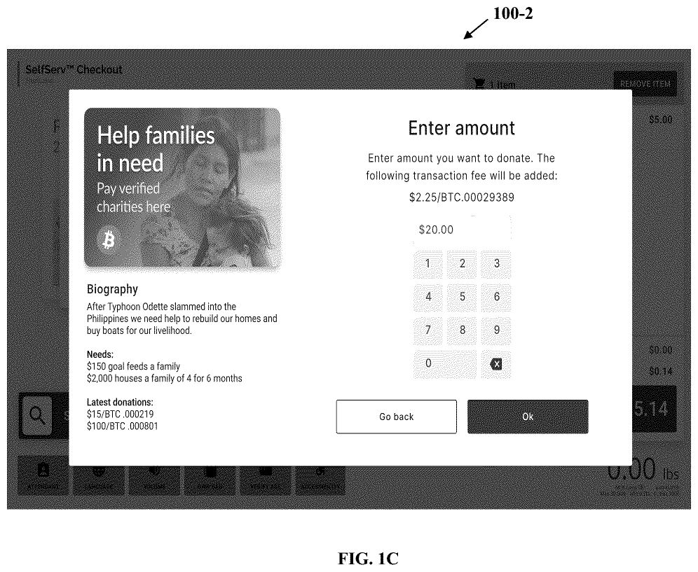

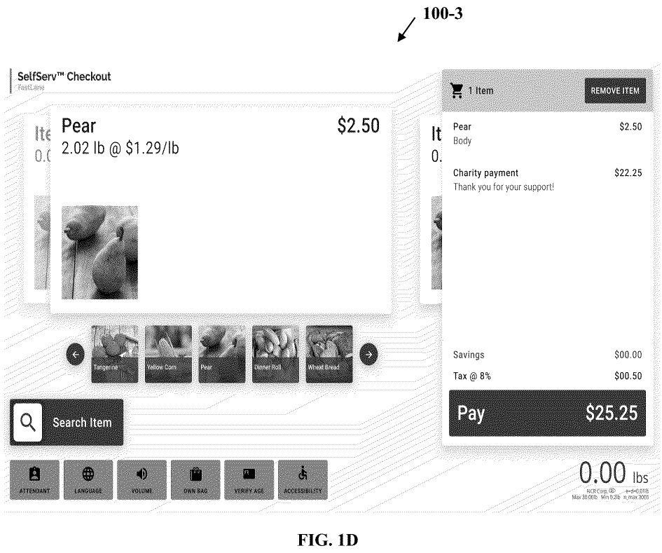

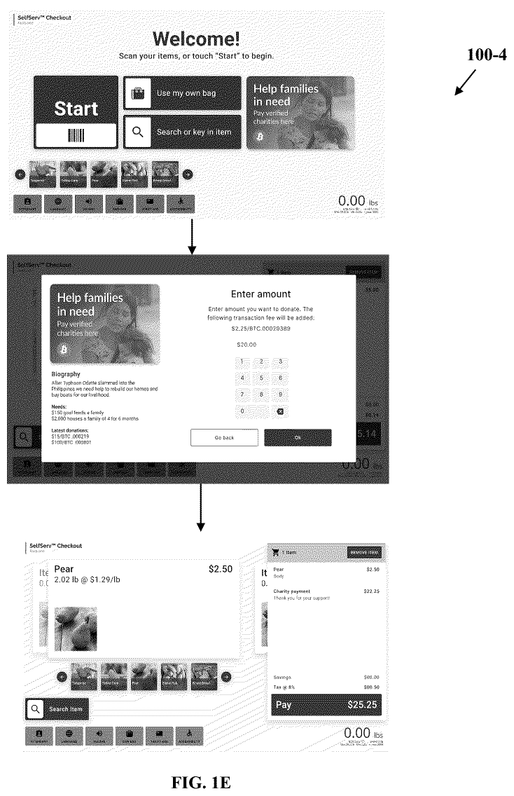

FIG. 1A is a diagram of a system 100 for donation-based transaction integration, according to an example embodiment. The system 100 is shown schematically in greatly simplified form, with only those components relevant to understanding of one or more embodiments (represented herein) being illustrated. The various components are illustrated, and the arrangement of the components are presented for purposes of illustration only. It is to be noted that other arrangements with more or less components are possible without departing from donation-based transaction integration presented herein and below.

Moreover, various components are implemented as one or more software modules, which reside in non-transitory storage and/or hardware memory as executable instructions that when executed by one or more hardware processors perform the processing discussed herein and below.

System 100 includes a cloud 110 or a server 110 (hereinafter just “cloud 110”), transaction terminals 120, management terminals 130, charitable organization servers 140, and distributed BC devices/servers 150. Cloud 110 includes one or more processors 111 and a non-transitory computer-readable storage medium 112 (herein after just “medium”), which includes instructions for a transaction manager 113, a wallet manager 114, an application programming interface (API) 115, a donation manager 116, and a BC API 117. The instructions when provided to processor 111 cause processor 111 to perform operations discussed herein and below with respect to 113-117.

Each transaction terminal 120 includes one or more processors 121 and medium 122, which includes instructions for transaction manager 123 and donation agent 124. The instructions when provided to processor 121 cause processor 121 to perform operations discussed herein and below with respect to 123-124.

Each management terminal 130 includes one or more processors 131 and medium 132, which includes instructions for a donation interface 133. The instructions when provided to processor 131 cause processor 131 to perform operations discussed herein and below with respect to 133.

Each charitable organization server 140 includes one or more processors 141 and medium 142, which includes instructions for a wallet application 143 and a registration interface 144. The instructions when provided to processor 141 cause processor 141 to perform operations discussed herein and below with respect to 143 and 144.

Each distributed BC device/server 150 includes one or more processors 151 and medium 152, which includes instructions for BC APIs 152. The instructions when provided to processor 151 cause processor 151 to perform operations discussed herein and below with respect to 153. BC devices/servers 150 maintain the BC.

Initially, charitable organizations register to be included in donations being collected by a retailer or stores of the retailer using registration interface 144 which interacts with donation manager 116. During registration, a registering organization provides a cryptocurrency wallet identifier (e.g., wallet address) associated with that organization's wallet application (herein after just “app”) and the registering organization provides a summary page of information about the works and history of the organization.

Donation manager 116 then vets each registered organization. This can be done in a variety of manners, such as through third-party services that rate organizations based on their charitable giving and operational expenses relative to the giving. Donation manager 116 may also inspect the public ledger on the BC using the wallet identifier of the registering organization. This will show donations received and funds withdrawn and to what wallets withdrawn funds were sent. Based on third-party services and their ratings and an analysis of a registering organization's BC ledger, the registering organization receives a score, when the score is above a threshold value, the registering organization is accepted to receive consideration of donations from the retailer.

Alternatively or additionally, the retailer or a store of a retailer can register charities for consideration by donation manager 116 through donation interface 133. This can be done by scanning the cryptocurrency wallet identifier during registration at the management terminal 130 through the donation interface 133 and providing a link to a web page of the charity that provides a summary about the works of the charity. Again, donation manager 116 vets the suggested charity before inclusion in a list of charities available from donation manager 116.

Donation manager 116 maintains a data store or a table of vetted registered charities alone with their wallet identifiers and summary pages of information or links to their summary pages. At the conclusion of a predefined period of time, donation manager 116 selects a certain number of the charities for potential inclusion in a next period of time as a charitable organization that a store of a retailer can select for receiving donations from customers of a given store.

A manager of a retail store interacts with donation interface 133 for purposes of selecting a charity from the certain number of charities determined by the donation manager 133 for the next period of time. Once the manager selects the charity, donation manager 116 sends the selected charity's wallet identifier and link to its summary page to donation agent 124.

On a transaction splash screen associated with a transaction interface of transaction manager 123, a sub-screen is rendered by donation agent 124 that identifies the charity or the type of charity. This sub-screen is maintained within the transaction interface so as to not interface with transaction information or transaction options being presented by the transaction interface during the transaction as the transaction interface screens change during the transaction. It is noted that at this point there is no modification to the transaction manager 123 nor to the transaction interface since the sub-screen can be overlayed on top of and positioned by the donation agent 124 so as to not interfere with the transaction interface screens.

Whenever a customer touches the sub-screen during the transaction, donation agent 124 renders a new sub-screen overlaid on top of the transaction screens for the customer to enter an amount of the donation and/or for the customer to obtain the full summary page of information on the charity. The new sub-screen includes options processed by donation agent 124, the options can include to go back to the transaction screens which will stop the overlay of the new sub-screen and return the customer to the transaction screens with the original sub-screen occupying unused space of the transaction screens such that it is still visible to the customer for re-selection if desired. The sub-screen can also include a keypad for the customer to enter a donation amount along with an enter or “OK” option. Furthermore, an option to view the summary information page for the customer may be available that when selected renders the page via a link within yet another sub-screen. This further summary page can include a “go back” or “return option that will return the customer back to the new sub-screen where the customer is able to enter a donation or return back to the transaction interface screens without providing any donation.

When the customer enters a donation amount through the new sub-screen or the donation screen and selects enter or “OK,” the donation agent 124 receives the donation amount and communicates the donation amount via an API to transaction manager 123. Transaction manager 123 adds the donation amount to the running transaction total along with a line item indicating that the donation amount is to go to the charity. When a customer is set to pay, the transaction screen renders a line-item detail screen to the customer with options to remove items, the customer can elect to remove the donation line item before proceeding to pay.

Once the customer pays for the transaction, donation agent 124 notifies wallet manager 114 with the wallet identifier of the charity and with the amount. Wallet manager 114 initiates a cryptocurrency purchase operation with a cryptocurrency exchange for the donation amount which causes the exchange to collect the donation amount from a financial account registered to cloud 110, purchase the cryptocurrency, and transfer the cryptocurrency over the BC into a wallet identifier associated with a wallet of the store. The cloud 110 may also maintain a ledger indicating the funds that are to be received from the store for the donation amount and the amount of cryptocurrency that was purchased using the funds. The ledger may also include a variety of additional information such as store identifier, terminal identifier, transaction identifier, transaction details, calendar date, time of day, etc.

At a store-set interval of time, the cryptocurrency held in the store's wallet by wallet manager 114 for the charity is transferred over the BC using BC API 117 and BC APIs 153 to the charity's wallet using the charity's wallet identifier. The BC maintains a public ledger for the store's wallet using the store's wallet identifier which shows the funds moving into and out of the store's wallet and the wallet identifiers that received transfers from the store's wallet. This allows donation manager 117 to generate reports for the store and/or the retailer associated with the store and other stores that have other store wallets with cloud 110. Donation interface 113 can be operated to obtain the reports and define custom reports. For example, a report requested for store X may indicate that store X donated over $1,000,000 to Toys for Tots® in the last fiscal year.

FIG. 1B is a sample screen generated by the donation agent 124 that includes a customer option to donate to a charitable organization during a transaction on a terminal 120, according to an example embodiment. The sample screen is overlaid on top of and to the side of a transaction splash screen on a display of terminal 120 before a transaction is initiated by a customer for a self-service transaction on terminal 120. The donation agent 124 generates and renders the “Help families in need” screen whereas the transaction splash screen includes all of the other information and options presented in screen 100-1.

FIG. 1C is a sample screen generated by a donation agent 124 that includes entry fields for the customer to indicate a specific donation amount, according to an example embodiment. Donation agent 124 overlays the sample screen on top of the current transaction screen, which is the blackened area behind the sample screen presented in screen 100-2. This is a donation entry screen rendered by donation agent 124 when the customer selected the sample screen of FIG. 1B for purposes of making a donation to a selected charity. The donation entry screen can include a touch keypad for entry by the customer of a donation amount. The customer is informed in the donation entry screen that any amount entered is going to be levied a transaction fee of $2.25 on top of the donation amount desired by the customer. This transaction fee is automatically converted into an equivalent amount Bitcoin® (BTC) and presented to the customer as additional information. Further information or the summary information for the charity is also presented in the donation entry screen, such as the charity's needs or goals, bibliographic information, and latest donations received for the charity. The latest donations received is provided and calculated by the donation agent 124 and/or by donation manager 116 which dynamically provides the latest donation values to the donation agent 124 when the donation agent 124 renders the donation entry screen. The donation entry screen also includes a “Go back” button or option, which when activated by the customer cancels any donation and returns to the transaction interface screens for the customer's transaction. Further, the donation entry screen includes an “Ok” button or option, which when activated cause donation agent 124 to use an API and communicate a line-item detail for the charity and the donation amount plus the transaction fee for the transaction manager 123 to add to the running total of the transaction.

FIG. 1D is a sample screen generated by a transaction manager 123 of the terminal 120 that shows a total for the customer transaction with the donation amount included with other items purchased by the customer, according to an example embodiment. Screen 100-3 illustrates a transaction interface screen state for a transaction generated by transaction manager 123 after receiving a donation amount from donation agent 124 during a transaction and when the customer has selected the pay option or checkout option for the transaction. The line-item includes a charity payment of $22.25, which comports with the $2.25 transaction fee and the $20 donation amount entered by the customer in the donation entry screen of FIG. 1C.

FIG. 1E is a diagram illustrating the screen transitions 100-4 during a transaction in which a donation is made by a customer, according to an example embodiment. The screen transitions 100-4 comport with the running example illustrated in FIGS. 1B, 1C, and 1D. The sample screen of FIG. 1B is positioned on the transaction splash screen of terminal 120 so as not to interfere with the options and information of the splash screen. When a customer selects the sample screen generated by donation agent 124, donation agent 124 overlays the donation entry screen of FIG. 1C on top of existing transaction interface screens being rendered by transaction manager 123. When the customer enters the donation amount in the donation entry screen, donation agent 124 uses an API to inform the transaction manager 123 that a line-item for a charitable donation is to be added to the transaction total in an amount equal to what the customer entered and the transaction fee (i.e. $22.25 in the running example). Transaction manager 123 then, in response to the customer indicating that the customer is ready to pay or checkout, generates a line-item details screen for the transaction total which includes items purchased for the customer and the charitable donation with service fee as was shown in FIG. 1D.

System 100 integrates seamlessly and nearly transparently into the transaction workflow of a terminal 120. The donation screens and workflow are independent and separate from the transaction workflow. Integration is achieved through a single API call between the donation agent 124 and transaction manager 123 for purposes of communicating a line-item to add to the transaction running total for a charitable donation including any added service fee. Minimal changes are needed to the transaction manager 123 and no changes are required to the transaction workflow for purposes of achieving donation-based transaction integration.

System 100 permits retailers and customers of retailers to give back to their community and help those in need through a non-intrusive and transaction integration approach. Customers do not feel pressured for donations as customers affirmatively make the choice as to whether to donate or not and such decisions of the customers are maintained in privacy. The donations are made via cryptocurrency wallet-to-wallet transactions which incur minimal fees over the BC, leave audit trails, maintain ledgers, and provide enhanced security. Additionally, funds can be transferred worldwide without fiat currency conversion fees.

In an embodiment, terminal 120 is a self-service terminal (SST), self-checkout, automated teller machine (ATM), or a point-of-sale (POS) terminal. In the case of a cashier-assisted POS transaction, the customer can select the donation entry screen on a customer-facing display at any point during the transaction and before payment such that the cashier is unaware of the customer's donation until payment is requested. This alleviates the cashiers of feeling pressure to ask customers for donations.

In an embodiment, donation interface 133 permits a store manager to override charity selections and designate a charitable organization for vetting and for setting as the store's charity for a set-period of time. Donation manager 116 sets the charity overridden on donation agent 124. In this way, store employees can rally around a specific cause that is important to them and override available selections determined by the donation manager 116.

In an embodiment, a store manager can set the period of time during which a single charity is being offered for customer donations on their store terminals 120 via donation interface 133 through interaction with donation manager 116. For example, a single charity may be available for donations through donation agent 124 within the manager's store for 1 week, 1 month, 3 months, etc.

In an embodiment, a store manager can set the interval of time for wallet manager 114 to transfer cryptocurrency donations to the charities. For example, a selected charity's donations received are transferred from the store's wallet managed by wallet manager 114 to the charity's wallet once a day, twice a week, once a week, once a month, etc.

In an embodiment, the line-item detail provided by agent 124 to transaction manager 123 for a donation includes a legal entity name for the charitable organization and its registered business address. The transaction receipt printed for a customer transaction includes this level of detail for the donation. This permits the customer to use the receipt in support of taking a charitable donation on their taxes.

In an embodiment, an authorized retail user or regional manager can operate management terminal 130 for purposes of selecting a charitable organization for presentation by donation agent 124 via donation manager 116 on terminals 120 associated with a user-defined group of stores. Thus, a regional chain of stores can provide customers the same charitable organization to donate to during their transactions.

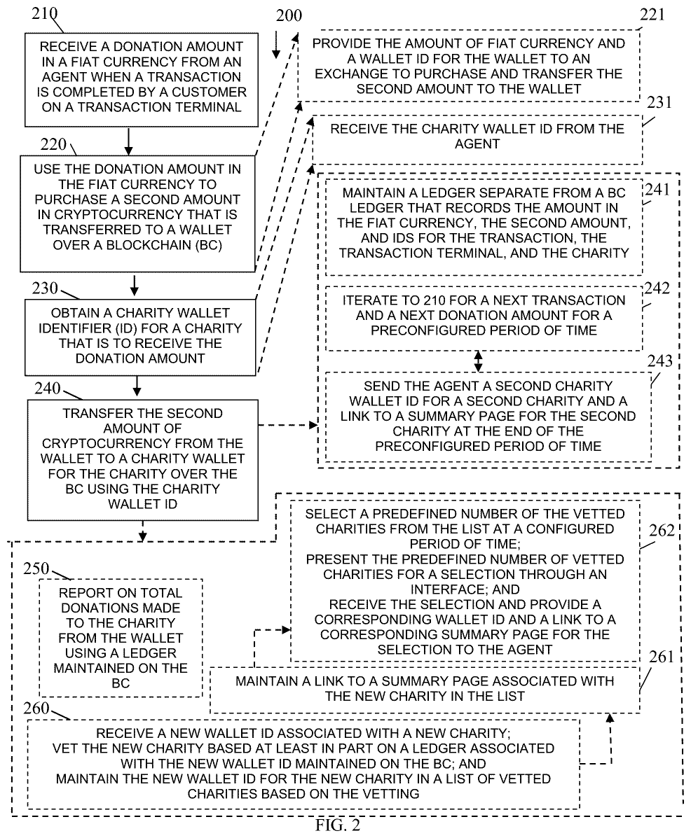

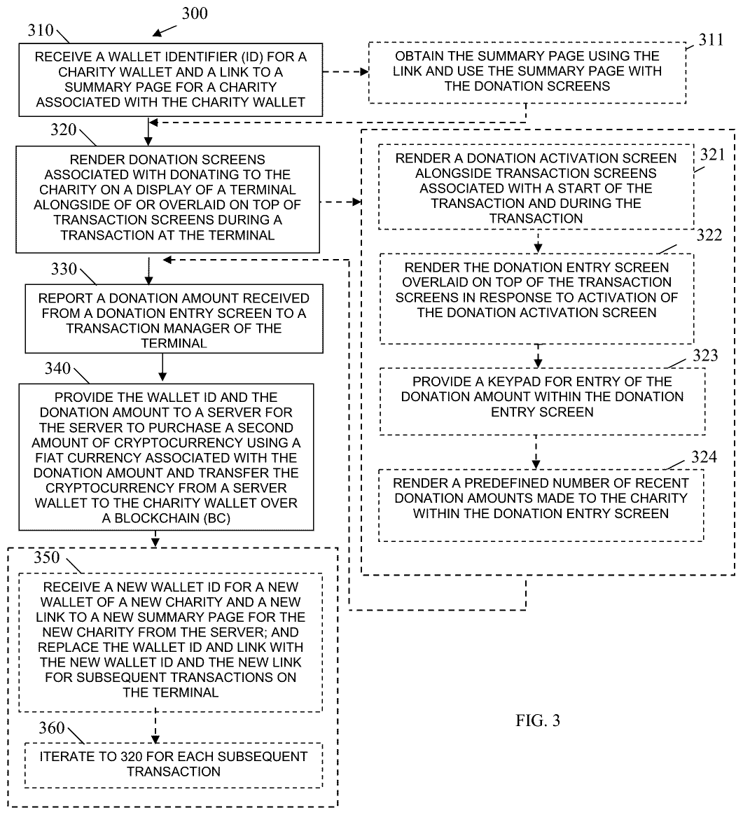

The embodiments of FIGS. 1A, 1B, 1C, 1D, 1E, and other embodiments are now discussed with reference to the FIGS. 2-3. FIG. 2 is a flow diagram of a method 200 for donation-based transaction integration, according to an example embodiment. The software module(s) that implements the method 200 is referred to as a “transaction donation manager.” The transaction donation manager is implemented as executable instructions programmed and residing within memory and/or a non-transitory computer-readable (processor-readable) storage medium and executed one or more hardware processors of one or more hardware computing devices. The processors of the devices that execute the transaction donation manager are specifically configured and programmed to process the transaction donation manager. The transaction donation manager has access to one or more networks during its processing. The networks can be wired, wireless, or a combination of wired and wireless.

In an embodiment, the device that executes the transaction donation manager is cloud 110. In an embodiment, the device that executes the transaction donation manager is server 110. In an embodiment, the remittance service is all or some combination of 114, 115, 116, 117, 124, 133, and/or 144, as discussed above with system 100.

At 210, the transaction donation manager receives a donation amount in a fiat currency from an agent 124 when a transaction is completed by a customer on a terminal 120. That is, when a transaction manager 123 indicates that payment was received for completion of the transaction, agent 124 reports the donation amount made by the customer in a fiat currency.

At 220, the transaction donation manager uses the donation amount in the fiat currency to purchase a second amount in cryptocurrency that is transferred to a wallet over a BC. The wallet is maintained by the transaction donation manager. In an embodiment, the cryptocurrency is BTC or ETH.

In an embodiment, at 221, the transaction donation manager provides the amount of fiat currency and a wallet identifier for the wallet of the transaction donation manager to an exchange to purchase the cryptocurrency and transfer the second amount of cryptocurrency to the wallet. A funds transfer can be initiated using an API of the exchange for the transaction donation manager to provide the amount of fiat currency from a financial account associated with the entity or retailer that operates the terminal 120 or that operates the transaction donation manager.

At 230, the transaction donation manager obtains a charity wallet identifier for a charity that is to receive the donation amount. In an embodiment, at 231, the transaction donation manager receives the charity wallet identifier from the agent 124. In an embodiment, the transaction donation manager knows the current charity available for donations on the terminal 120 and obtains the charity wallet identifier based on a charity identifier associated with the charity.

At 240, the transaction donation manager transfers the second amount of cryptocurrency from the wallet of the transaction donation manager to a charity wallet for the charity over the BC using the charity wallet identifier. This is a wallet-to-wallet transfer and experiences less fees and quicker response times from the BC.

In an embodiment, at 241, the transaction donation manager maintains a ledger separate from a BC ledger of the BC. The ledger records the amount in the fiat currency, the second amount of the cryptocurrency, and identifiers for the transaction, the transaction terminal and the charity.

In an embodiment, at 242, the transaction donation manager iterates to 210 for a next transaction and a next donation from another customer at a preconfigured period of time. In an embodiment of 242 and at 243, the transaction donation manager sends the agent a second charity wallet identifier for a second charity and a link to a summary page for the second charity at the end of the preconfigured period of time. That is, the charity available for donations changes at the end of each preconfigured period of time.

In an embodiment, at 250, the transaction donation manager reports on total donations made to the charity from the wallet using a ledger maintained on the BC. The wallet identifier for the wallet of the transaction donation manager and the charity wallet identifier each have ledgers that are publicly accessible on the BC. The transaction donation manager accesses these ledgers to report the total donations made to the charity by the retailer associated with the terminal 120.

In an embodiment, at 260, the transaction donation manager receives a new wallet identifier associated with a new charity. The transaction donation manager vets the new charity based at least in part on a ledger associated with the new wallet identifier maintained on the BC. The transaction donation manager maintains the new wallet identifier for the new charity in a list of vetted charities based on the vetting.

In an embodiment of 260 and at 261, the transaction donation manager maintains a link to a summary page associated with the new charity in the list. In an embodiment of 261 and at 262, the transaction donation manager selects a predefined number of the vetted charities from the list at a configured period of time. The transaction donation manager presents the predefined number of vetted charities for a selection through an interface 133. The transaction donation manager receives the selection and provides a corresponding wallet identifier and a link to a corresponding summary page for the selected vetted charity to the agent 124.

FIG. 3 is a flow diagram of another method 300 for donation-based transaction integration, according to an example embodiment. The software module(s) that implements the method 300 is referred to as a “transaction donation agent.” The transaction donation agent is implemented as executable instructions programmed and residing within memory and/or a non-transitory computer-readable (processor-readable) storage medium and executed by one or more hardware processors of one or more hardware devices. The processors of the devices that execute the transaction donation agent are specifically configured and programmed to process the transaction donation agent. The transaction donation agent has access to one or more networks during its processing. The networks can be wired, wireless, or a combination of wired and wireless.

The transaction donation agent interacts with the method 200. In an embodiment, the device that executes the transaction donation agent is transaction terminal 120. In an embodiment, terminal 120 is an SST, a POS terminal, an ATM, or a self-checkout terminal. In an embodiment, the transaction donation agent is all or some combination of 123 and/or 124.

At 310, the transaction donation agent receives a wallet identifier for a charity wallet and a link to a summary page of information for a charity associated with the charity wallet. In an embodiment, at 311, the transaction donation agent obtains the summary page using the link and uses the summary page when rendering donation screens.

At 320, the transaction donation agent renders donation screens associated with donating to the charity on a display of a terminal 120. The donations screens are rendered alongside of or overlaid on top of transaction screens during a transaction at the terminal 120.

In an embodiment, at 321, the transaction donation agent renders a donation activation screen alongside transaction screens associated with a start of a transaction and during a transaction. A sample donation activation screen is illustrated in FIGS. 1B and 1E above.

In an embodiment of 321 and at 322, the transaction donation agent renders the donation entry screen overlaid on top of the transaction screens in response to a customer activation of the donation activation screen. A sample donation entry screen is illustrated in FIGS. 1C and 1E above.

In an embodiment of 322 and at 323, the transaction donation agent provided a keypad for entry of the donation amount within the donation activation screen. The keypad is illustrated in FIGS. 1C and 1E above.

In an embodiment of 323 and at 324, the transaction donation agent renders a predefined number of recent donation amounts made to the charity within the donation entry screen. The bottom left of the donation entry screen as illustrated in FIGS. 1C and 1E above show two sample recent donations made for the Help Families in Need charity.

At 330, the transaction donation agent reports a donation amount received from a donation entry screen to a transaction manager 123 of the terminal 120. The transaction manager 123 integrates the donation amount as a line-item charity donation being made by a customer with the transaction details presented to the customer before payment of the transaction.

At 340, the transaction donation agent provides the wallet identifier and the donation amount to a server 110. The server 110 purchases a second amount of cryptocurrency using a fiat currency associated with the donation amount and transfers the cryptocurrency from a server-maintained wallet to the charity wallet over a BC.

In an embodiment, at 350, the transaction donation agent receives a new wallet identifier and a new link to a new summary page for a new charity from the server 110. The transaction donation agent replaces the wallet identifier and the link with the new wallet identifier and the new link for subsequent transactions on the terminal 120. In an embodiment, at 360, the transaction donation agent iterates to 320 for each subsequent transaction.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving a donation amount in a fiat currency from an agent when a transaction is completed by a customer on a transaction terminal;
using the donation amount in the fiat currency to purchase a second amount of cryptocurrency that is transferred to a wallet over a blockchain;
obtaining a charity wallet identifier for a charity that is to receive the donation amount; and
transferring the second amount of cryptocurrency from the wallet to a charity wallet of the charity over the blockchain using the charity wallet identifier.

2. The method of claim 1 further comprising, reporting on total donations made to the charity from the wallet using a ledger maintained on the blockchain.

3. The method of claim 1 further comprising:
receiving a new wallet identifier associated with a new charity;
vetting the new charity based at least in part on a ledger associated with the new wallet identifier maintained on the blockchain; and
maintaining the new wallet identifier for the new charity in a list of vetted charities based on the vetting.

4. The method of claim 3, wherein maintaining further include maintaining a link to a summary page associated with the new charity in the list.

5. The method of claim 4 further comprising:
selecting a predefined number of the vetted charities from the list at a configured period of time;
presenting the predefined number for a selection through an interface;
receiving the selection and providing a corresponding wallet identifier and a link to a corresponding summary page for the selection to the agent.

6. The method of claim 1, wherein using further includes providing the amount of fiat currency and a wallet identifier for the wallet to a cryptocurrency exchange to purchase and transfer the second amount to the wallet.

7. The method of claim 1, wherein obtaining further includes receiving the charity wallet identifier from the agent.

8. The method of claim 1, wherein transferring further includes maintaining a ledger separate from a blockchain ledger that records the fiat currency amount, the second amount, and identifiers for the transaction, the transaction terminal, the charity.

9. The method of claim 1, wherein transferring further includes iterating to the receiving for a next transaction and a next donation amount for a preconfigured period of time.

10. The method of claim 9, wherein iterating further includes sending the agent a second charity wallet identifier for a second charity and a link to a summary page for the second charity at the end of the preconfigured period of time.

11. A method, comprising:
receiving a wallet identifier for a charity wallet and a link to a summary page for a charity associated with the charity wallet;
rendering donation screens associated with donating to the charity on a display of a terminal alongside of or overlaid on top of transaction screens during a transaction at the terminal;
reporting a donation amount received from a donation entry screen to a transaction manager of the terminal; and
providing the wallet identifier and the donation amount to a server for the server to purchase a second amount of cryptocurrency using a fiat currency associated with the donation amount and for the server to transfer the second amount of cryptocurrency from a server wallet to the charity wallet over a blockchain.

12. The method of claim 11 further comprising:
receiving a new wallet identifier for a new wallet of a new charity and a new link to a new summary page for the new charity from the server; and
replacing the wallet identifier and the link with the new wallet identifier and the new link for subsequent transactions on the terminal.

13. The method of claim 12 further comprising, iterating to the rendering for each subsequent transaction.

14. The method of claim 11, wherein receiving further includes obtaining the summary page using the link and rendering the summary page in the donation screens.

15. The method of claim 11, wherein rendering further includes rendering a donation activation screen alongside transaction screens associated with a start of the transaction and during the transaction.

16. The method of claim 15, wherein rendering the donation entry screen overlaid on top of the transaction screens in response to activation of the donation activation screen.

17. The method of claim 16, wherein rendering the donation entry screen further includes providing a keypad for entry of the donation amount within the donation entry screen.

18. The method of claim 17, wherein rendering the donation entry screen further includes rendering a predefined number of recent donation amounts made to the charity within the donation entry screen.

19. A system comprising:
a server comprising at least one processor and a non-transitory computer-readable storage medium;
the non-transitory computer-readable storage medium comprising executable instructions;
the executable instructions when provided to or obtained by the at least one processor from the non-transitory computer-readable storage medium cause the at least one processor to perform operations, comprising:
maintaining a list of vetted charities;
maintaining for each vetted charity a wallet identifier for a cryptocurrency wallet of the corresponding vetted charity and a link to a summary page for the corresponding vetted charity;
providing a predefined number of the vetted charities at a first predefined period of time for selection through an interface;
receiving, through the interface, a selected vetted charity from the predefined number of the vetted charities;
obtaining the corresponding wallet identifier and the corresponding summary page for the selected vetted charity from the list;
providing the corresponding wallet identifier and the link associated with the corresponding summary page to an agent of a terminal;
receiving donation amounts and the corresponding wallet identifiers from the agent during transactions on the terminal;
for each donation amount:
purchasing cryptocurrency from an exchange using a fiat currency associated with the corresponding donation amount and transferring the purchased cryptocurrency to a server wallet associated with the server;
at second predefined periods of time, transferring the cryptocurrency from the server wallet to the corresponding wallet of the selected vetted charity over a blockchain using the corresponding wallet identifier.

20. The system of claim 19, wherein the executable instructions when provided to or obtained by the at least one processor from the non-transitory computer-readable storage medium further cause the at least one processor to perform additional operations, comprising:
providing reports through the interface for total donation amounts per vetted charity and per user-defined periods of time using ledgers maintained on the blockchain for the server wallet and the cryptocurrency wallets of the vetted charities.
